(19) United States
(12) Patent Application Publication
(10) Pub. No.: US 2017/0090526 A1
(43) Pub. Date: Mar. 30, 2017

(54) MOUNTING APPARATUS FOR STORAGE DEVICE

(71) Applicant: HON HAI PRECISION INDUSTRY CO., LTD., New Taipei (TW)

(72) Inventor: KUO-FENG CHEN, New Taipei (TW)

(21) Appl. No.: 14/886,223

(22) Filed: Oct. 19, 2015

(30) Foreign Application Priority Data
Sep. 29, 2015 (CN) 201510630953.0

(51) Int. Cl. G06F 1/18

(52) U.S. Cl. CPC G06F 1/187

(57) ABSTRACT

A mounting apparatus includes a handle, a coupling arm movably attached to the handle; and a mounting bracket. The mounting bracket includes a side frame slidably attached to the coupling arm. The side frame includes a securing post. The mounting bracket, the coupling arm and the handle cooperatively defines a receiving space configured for receiving a storage device. When the storage device is received in the receiving space, the handle is slid along with the coupling arms relative to the side frame to engage the securing post in the securing hole.

### FIELD

The subject matter herein generally relates to mounting apparatus for mounting a storage device.

### BACKGROUND

Many servers include data storage devices such as hard disk drives (HDDs), floppy disk drives, and compact disc-read only memory (CD-ROM) drives. Data storage devices are received in a bracket that is attached to a server enclosure. A screw can be used to attach the bracket.

### BRIEF DESCRIPTION OF THE DRAWINGS

Implementations of the present technology will now be described, by way of example only, with reference to the attached figures.

FIG. 1 is an exploded, isometric view of an embodiment of a mounting apparatus and a storage device.

FIG. 2 is an exploded, isometric view of the mounting apparatus of FIG. 1.

FIG. 3 is an assembled view of the mounting apparatus and the storage device of FIG. 1.

FIG. 4 is a cross-section view of FIG. 3, taken along a line VI-VI, and the storage device is disengaged from the mounting apparatus.

FIG. 5 is similar to FIG. 4, and the storage device is engaged with the mounting apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a mounting apparatus. The mounting apparatus includes a handle, a coupling arm movably attached to the handle; and a mounting bracket. The mounting bracket includes a side frame slidably attached to the coupling arm. The side frame includes a securing post. The mounting bracket, the coupling arm and the handle cooperatively define a receiving space configured for receiving a storage device. When the storage device is received in the receiving space, the handle is slid with the coupling arm relative to the side frame to engage the securing post in the securing hole.

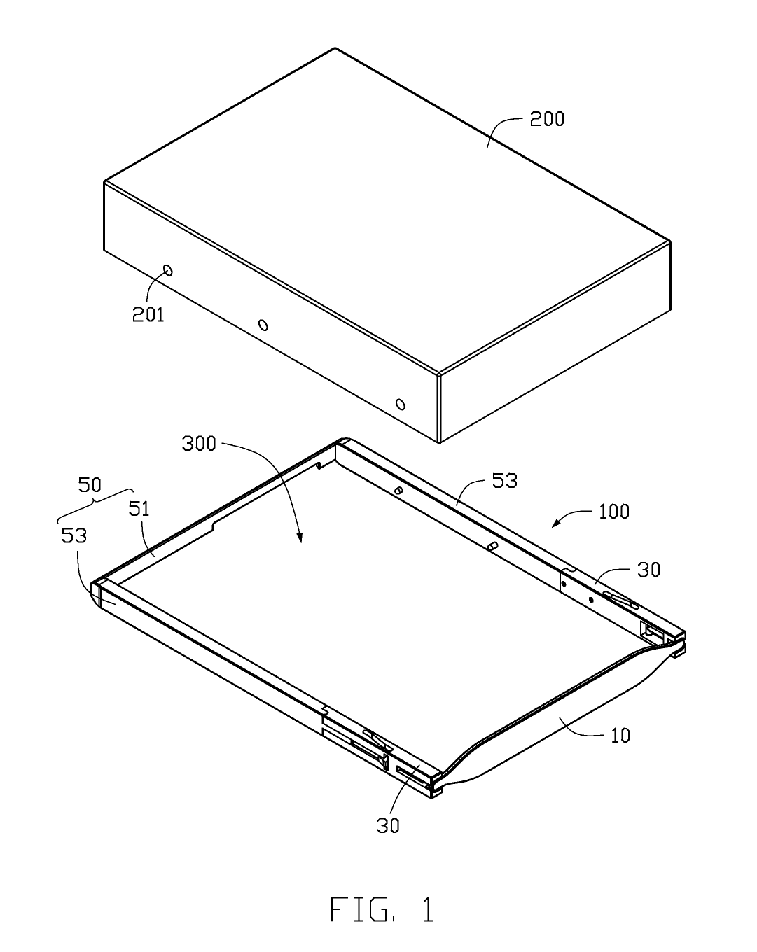

FIG. 1 illustrates an embodiment of a mounting apparatus 100 for securing a storage device 200. In at least one embodiment, the storage device 200 can be hard disk drives (HDDs), floppy disk drives, and compact disc-read only memory (CD-ROM) drives. A plurality of securing holes 201 is defined in opposite sides of the storage device 200.

The mounting apparatus 100 can include a handle 10, two coupling arms 30 movably attached to opposite ends of the handle 10, and a mounting bracket 50 slidably attached to the two coupling arms 30. The handle 10, the two coupling arms 30 and the mounting bracket 50 cooperatively define a receiving space 300 for receiving the storage device 200.

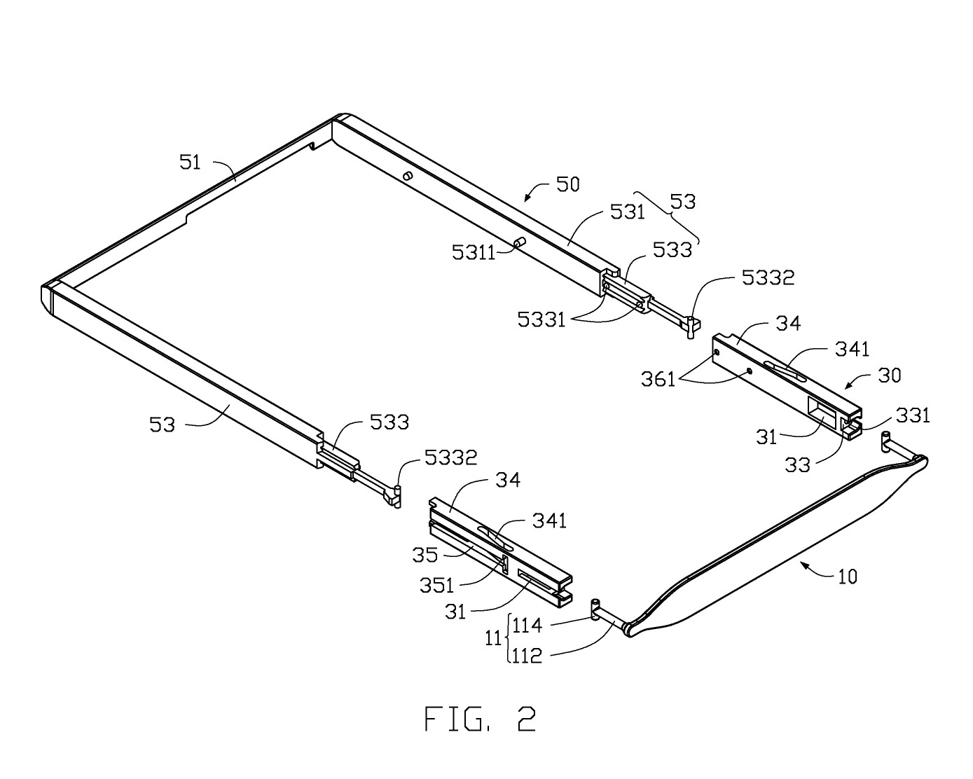

FIG. 2 illustrates the handle 10, the two coupling arms 30 and the mounting bracket 50. Two connecting portions 11 are located on opposite ends of the handle 10. Each connecting portion 11 can include a connecting pole 112 and a distal pole 114. In at least one embodiment, the distal pole 114 is substantially perpendicular to the connecting pole 112.

Each coupling arm 30 comprises an accommodating portion 31 and a blocking potion 33 located on an end of the accommodating portion 31. A through hole 331 is defined in the blocking portion 33. The connecting portion 11 can extend through the through hole 331 to be located in the accommodating portion 33. Each connecting arm 30 further can include a top panel 34, a bottom panel 35, and a side panel 36 coupled to the top panel 34 and the bottom panel 35. In at least one embodiment, the top panel 34 is substantially parallel to the bottom panel 35 and perpendicular to the side panel 36. A first sliding slot 341 is defined in the top panel 341, and a second sliding slot 351 is defined in the bottom panel 351. In at least one embodiment, the first sliding slot 341 is parallel to the second sliding slot 351, and the first sliding slot 341 and the second sliding slot 351 are slanted. Two positioning holes 361 are defined in the side panel 36.

The mounting bracket 50 can include a back frame 51 and two side frames 53 coupled to opposite ends of the back frame 51. Each side frame 53 can include a main body 531 and an extending portion 533 coupled to the main body 531. Two positioning portions 5311, correspond to the two positioning holes 361, and are located on an inner side of the extending portion 533. The extending portion 5311 can be slidably located between the top panel 34 and the bottom panel 35. A sliding post 5332 is located on a distal end of the extending portion 5311, and opposite ends of the sliding post 5332 can be slidably received in the first and second sliding slots 341, 351, respectively.

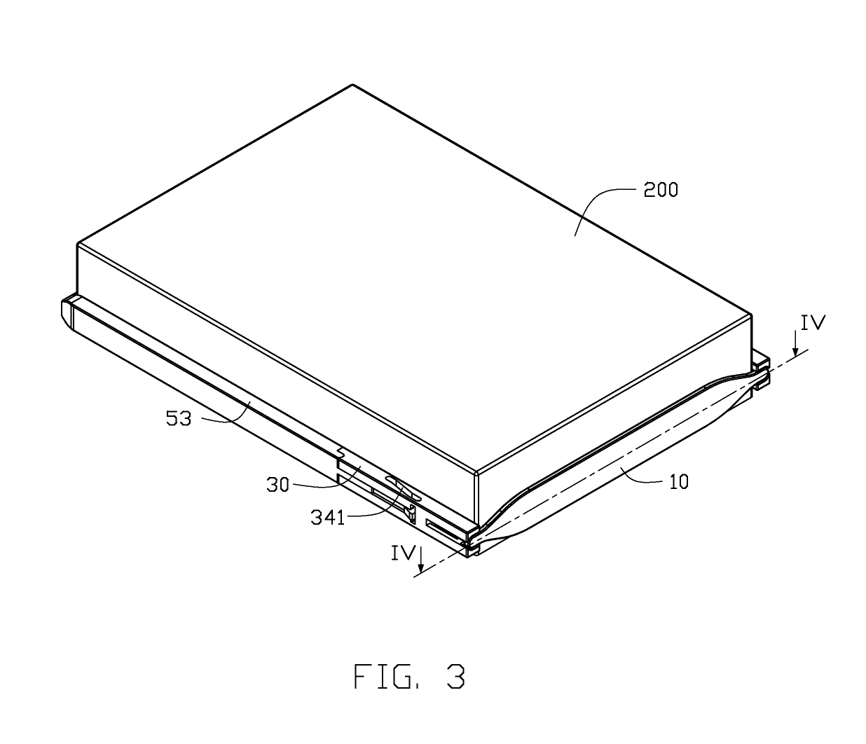

FIGS. 1 and 3 illustrate the mounting apparatus 100 during assembly. Each connecting portion 11 extends through each through hole 331 to be located in the accommodating portion 31 of each coupling arm 30. The coupling arm 30 is rotated relative to the connecting portion 11 to allow the connecting portion 11 to be engaged with the accommodating portion 31, and the distal pole 114 can be blocked by the blocking portion 33. Thus, the two coupling arms 30 can be slidably attached to the handle 10. Each extending portion 533 of the side frame 53 is located between the top panel 34 and the bottom panel 35, and the opposite ends of the sliding post 5332 are slidably received in the first and second sliding slots 341, 351, respectively, so that each extending portion 533 is slidably attached to each coupling arm 30.

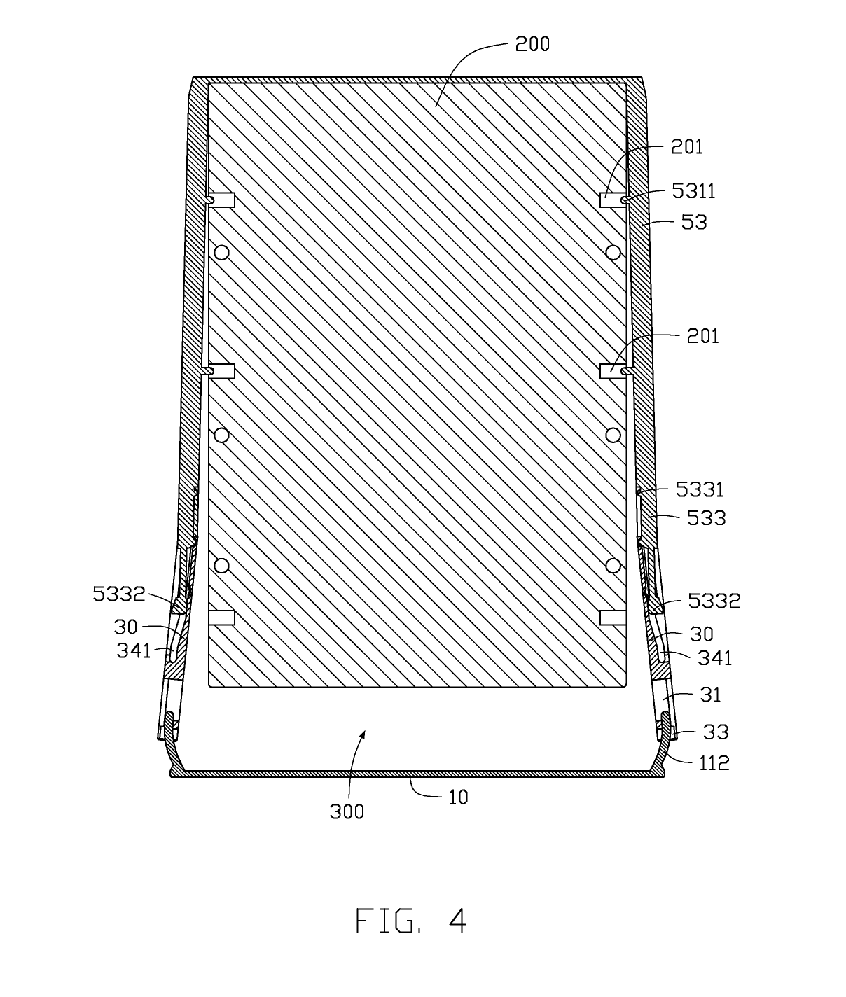

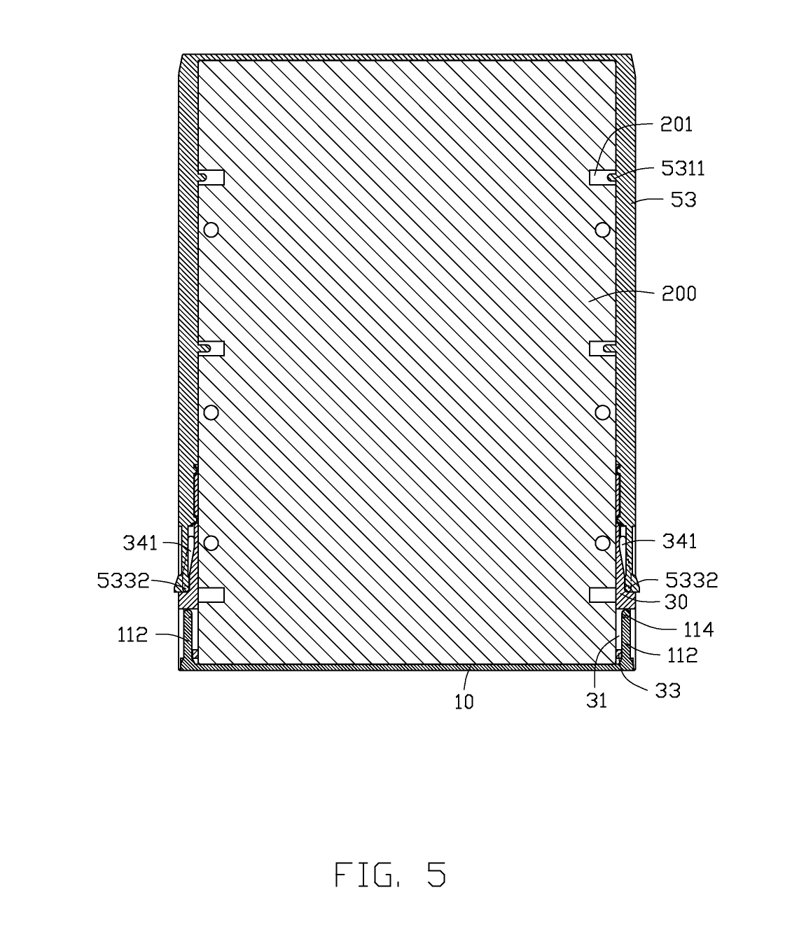

FIGS. 4 and 5 illustrate the storage device 200 being secured by the mounting apparatus 100. The handle 10 is slid relative to the two coupling arms 30 in a first direction away from the two coupling arms 30. Each connecting portion 11 is slid in each accommodating portion 30, until the distal pole 114 of each connecting portion 11 is blocked by the blocking portion 33. The handle 10 is further pulled along with the two coupling arms 30 in the first direction, until the opposite ends of the sliding post 5331 are located in a first end of the first and second sliding slots 341, 351. At this position, the two connecting arms 30 pull the two side frames 533 to extend outwardly, so that the storage device 200 can be located in the receiving space 300 (see FIG. 4).

Each securing post 5311 is aligned with each securing hole 201. The handle 10 is pushed in a second direction opposite to the first direction. The connecting portion 11 is slid in the accommodating portion 30, and the distal pole 114 to slide the coupling arm 30 in the second direction. The opposite ends of the sliding post 5331 are slid in the first and second sliding slots 341, 351, and the two positioning portions 5331 of each extending portion 533 are engaged in the two positioning holes 361 of each coupling arm 30. The two connecting arms 30 pull the two side frames 533 to extend inwardly to engage the securing posts 5311 in the securing holes 201. Thus, the storage device 200 is assembled (see FIG. 5).

In order to disassemble the storage device 200, the handle 10 is slid in the first direction, until the distal pole 114 of each connecting portion 11 is blocked by the blocking portion 33. The handle 10 is further slid, and the two positioning portions 5331 of each extending portion 533 are disengaged from the two positioning holes 361 of each coupling arm 30. The two coupling arms 30 are slid in the first direction, until the opposite ends of the sliding post 5331 are located in the first end of the first and second sliding slots 341, 351. The two connecting arms 30 pull the two side frames 533 to extend outwardly to disengage the securing posts 5311 from the securing holes 201. Thus, the storage device 200 can be disengaged from the mounting apparatus 100.

The embodiments shown and described above are only examples. Many details are often found in the art such as the other features of a mounting apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A mounting apparatus comprising:
a handle;
a coupling arm movably attached to the handle; and
a mounting bracket comprising a side frame slidably attached to the coupling arm, the side frame comprising a securing post, the mounting bracket, the coupling arm and the handle cooperatively defining a receiving space configured for receiving a storage device;
wherein when the storage device is received in the receiving space, the coupling arm is slid relative to the side frame by the handle to insert the securing post in the securing hole.

2. The mounting apparatus of claim 1, wherein the coupling arm comprises an accommodating portion, a connecting portion is coupled to the handle, and the connecting portion is slidably engaged with the accommodating portion.

3. The mounting apparatus of claim 2, wherein the coupling arm further comprises a blocking portion, the blocking portion defines a through hole, and the connecting portion extends through the through hole to be located in the accommodating portion.

4. The mounting apparatus of claim 3, wherein the connecting portion comprises a connecting pole and a distal pole, the connecting pole is substantially perpendicular to the handle, and the distal pole is substantially perpendicular to the connecting pole.

5. The mounting apparatus of claim 1, wherein the coupling arm defines a sliding slot, and the side frame comprises a sliding post slidably received in the sliding slot.

6. The mounting apparatus of claim 5, wherein the sliding slot is slanted.

7. The mounting apparatus of claim 5, wherein the coupling arm comprises a top panel, a bottom panel and a side panel coupled to the top panel and the bottom panel, and the side frame comprises an extending portion located between the top panel and the bottom panel.

8. The mounting apparatus of claim 7, wherein the side panel defines a positioning hole, and the extending portion comprises a positioning portion engaged in the positioning hole.

9. A mounting apparatus comprising:
a handle;
a coupling arm movably attached to the handle; the coupling arm defining a sliding slot; and
a mounting bracket comprising a side frame; the side frame comprising a sliding post slidably received in the sliding slot and comprising a securing post; the mounting bracket, the coupling arm and the handle cooperatively defining a receiving space configured for receiving a storage device;
wherein when the sliding post is located on a first end of the sliding slot, the side frame extend inwardly to engage the securing post in the securing hole, and when the sliding post is located on a second end of the sliding slot, the side frame extend outwardly to disengage the securing post from the securing hole.

10. The mounting apparatus of claim 9, wherein the coupling arm comprises an accommodating portion, a connecting portion is coupled to the handle, and the connecting portion is slidably engaged with the accommodating portion.

11. The mounting apparatus of claim 10, wherein the coupling arm further comprises a blocking portion, the blocking portion defines a through hole, and the connecting portion extends through the through hole to be located in the accommodating portion.

12. The mounting apparatus of claim 11, wherein the connecting portion comprises a connecting pole and a distal pole, the connecting pole is substantially perpendicular to the handle, and the distal pole is substantially perpendicular to the connecting pole.

13. The mounting apparatus of claim 10, wherein the sliding slot is slanted.

14. The mounting apparatus of claim 10, wherein the coupling arm comprises a top panel, a bottom panel and a side panel coupled to the top panel and the bottom panel, and the side frame comprises an extending portion located between the top panel and the bottom panel.

15. The mounting apparatus of claim 14, wherein the side panel defines a positioning hole, and the extending portion comprises a positioning portion engaged in the positioning hole.
